(19) United States
(12) Patent Application Publication
(10) Pub. No.: US 2020/0296908 A1
(43) Pub. Date: Sep. 24, 2020

(54) ENVIRONMENTAL CONTROL AND TRANSPORT SYSTEM FOR AGRICULTURAL PRODUCTS AND METHOD

(71) Applicant: Carrier Corporation, Palm Beach Gardens, FL (US)

(72) Inventor: Robert A. Chopko, Baldwinsville, NY (US)

(21) Appl. No.: 16/083,753

(22) PCT Filed: Mar. 8, 2017
(86) PCT No.: PCT/US2017/021334

§ 371 Date: Sep. 10, 2018

Related U.S. Application Data
(60) Provisional application No. 62/306,475, filed on Mar. 10, 2016.

(51) Int. Cl. A01G 31/06; F25D 11/00; F25D 17/04; F25D 27/00; F25D 29/00; A01G 7/04

(52) U.S. Cl. CPC A01G 31/06; F25D 11/003; A01G 7/045; F25D 27/00; F25D 29/003; F25D 17/042

(57) ABSTRACT

An environmental control and transport system for agricultural products is provided and includes a shipping container (12) comprising at least one zone (18) for containing an agricultural product therein, wherein the shipping container (12) is a self-powered electric unit. Also included is an evaporator (20) operatively coupled to the shipping container (12), the evaporator (20) controlling at least one environmental condition of the at least one zone (18).

### BACKGROUND OF THE DISCLOSURE

The embodiments herein generally relate to agricultural products and, more particularly, to an environmental control and transport system for agricultural products, as well as a method of growing and transporting such products.

Agricultural products are grown in various types of environments, with different products thriving in conditions that vary from each other. For example, temperature, humidity, soil conditions and lighting are all factors that can significantly impact the quality of the grown agricultural product. As such, it is desirable to control the growing conditions in a manner that is best suited for a particular product.

Subsequent to harvest, storage conditions are also of concern due to the perishable nature of the products. Therefore, the number of “handoffs” that occur along the handling chain can detrimentally affect the products, since products intended for consumers typically are transitioned between multiple parties, including a grower, transporter, distributor, grocery store, restaurant and end user. Such handoffs increase the likelihood that a product will not be optimally fresh by the time it is consumed by an end user. The public has become generally aware of this and the protection of produce from “farm-to-fork” is now in high demand for many consumers.

### BRIEF DESCRIPTION OF THE DISCLOSURE

According to one embodiment, an environmental control and transport system for agricultural products is provided and includes a shipping container comprising at least one zone for containing an agricultural product therein, wherein the shipping container is a self-powered electric unit. Also included is an evaporator operatively coupled to the shipping container, the evaporator controlling at least one environmental condition of the at least one zone.

In addition to one or more of the features described above, or as an alternative, further embodiments may include a hydroponics system disposed in the shipping container for growth of the agricultural product, the hydroponics system comprising at least one hydroponics support for supporting the agricultural product, wherein respiration loads produced by the agricultural product is condensed by the evaporator to form condensate that in turn supplements the hydroponics system.

In addition to one or more of the features described above, or as an alternative, further embodiments may include that the at least one zone of the shipping container comprises a plurality of zones, wherein the at least one environmental condition of each of the zones are independently controllable with the evaporator.

In addition to one or more of the features described above, or as an alternative, further embodiments may include that the at least one environmental condition comprises at least one of temperature, humidity, lighting quality, carbon dioxide and ethylene.

In addition to one or more of the features described above, or as an alternative, further embodiments may include a control device in wireless communication with the evaporator, the control device providing a user control over the at least one environmental condition within the shipping container.

In addition to one or more of the features described above, or as an alternative, further embodiments may include that the control device is in wireless communication with at least one condition detector disposed in the shipping container to monitor the environmental condition of the at least one zone within the shipping container.

In addition to one or more of the features described above, or as an alternative, further embodiments may include that the shipping container includes at least one data collection device in wireless communication with a cloud data storage system for tracking environmental conditions of the shipping container and growth of the agricultural product.

In addition to one or more of the features described above, or as an alternative, further embodiments may include a lighting system disposed within the shipping container.

In addition to one or more of the features described above, or as an alternative, further embodiments may include that the lighting system comprises a plurality of LEDs.

In addition to one or more of the features described above, or as an alternative, further embodiments may include that the lighting system is powered by the shipping container.

In addition to one or more of the features described above, or as an alternative, further embodiments include that the lighting system comprises a plurality of light spectrum analyzers manually or wirelessly connected to a system controller and configured to adjust the plurality of LEDs for optimized agricultural growth.

In addition to one or more of the features described above, or as an alternative, further embodiments include that the shipping container includes a plurality of wheels for transport of the agricultural product.

According to another embodiment, a method of agricultural product growth and transport is provided and includes growing an agricultural product within a shipping container with a hydroponics system disposed in the shipping container. The method also includes controlling at least one environmental condition with an evaporator mounted to the shipping container. The method further includes transporting the agricultural product to a destination within the shipping container.

In addition to one or more of the features described above, or as an alternative, further embodiments may include independently controlling the at least one environmental condition of a plurality of zones of the shipping container to selectively provide distinct growing conditions for the agricultural product.

In addition to one or more of the features described above, or as an alternative, further embodiments may include condensing respiration loads from the agricultural product to form a condensate that in turn supplements the hydroponics system.

In addition to one or more of the features described above, or as an alternative, further embodiments may include controlling the evaporator with a device wirelessly connected to the evaporator.

In addition to one or more of the features described above, or as an alternative, further embodiments may include collecting data with a data collection device disposed within the shipping container. Also included is transporting the data collected to a cloud storage device.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a perspective view of an environmental control and transport system for agricultural products; and

FIG. 2 is an enlarged view of a shipping container zone of the system of FIG. 1.

### DETAILED DESCRIPTION OF THE DISCLOSURE

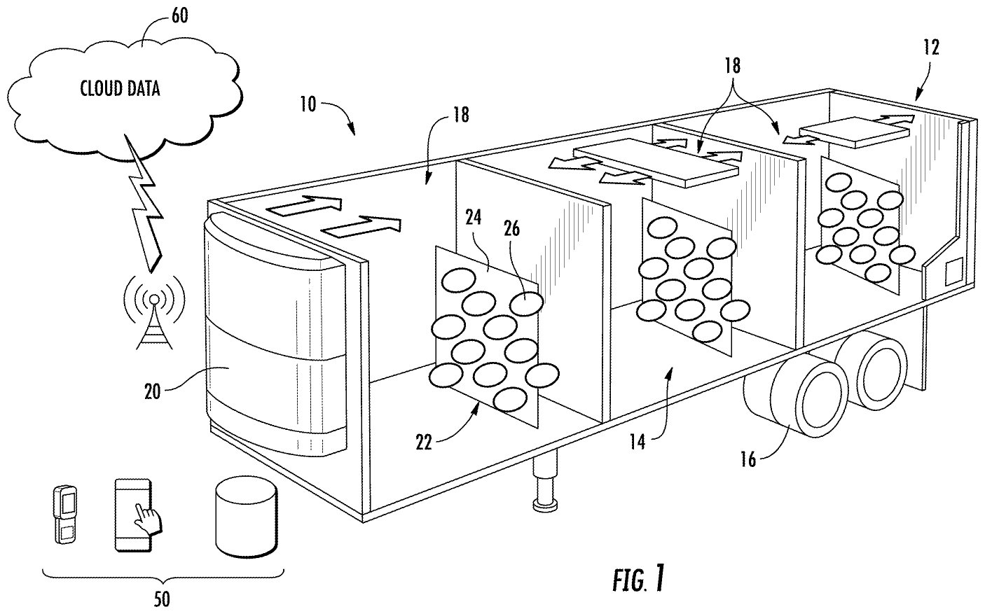

Referring to FIG. 1, an environmental control and transport system for agricultural products is schematically illustrated and generally referenced with numeral 10. The system 10 (also referred to herein as “transport refrigeration unit system” or “TRU system”) is employed to facilitate growth of agricultural products in any location and to transport the products to a destination, as needed, without the need for transitioning the grown products during the handling chain (may be referred to as “handoffs”). The agricultural products referred to herein may be any agricultural product, with an illustrative embodiment being produce consumed by end users.

The system 10 includes a shipping container 12 that defines at least one partially enclosed growing area 14. The shipping container 12 has a self-powered electric unit that facilitates electrical management of itself and all subsystems disposed therein. The shipping container 12 can be stationary or can be a moveable container with a plurality of wheels 16 to allow for the shipping container 12 to be towed by a vehicle. As will be appreciated from the disclosure, the towable nature of the shipping container 12 allows for the system 10 described herein to be moved to any location for growth of the agricultural products as well as subsequent transport, if needed. This advantageously allows the system to be located as close as desired to a final destination (e.g., grocery store, restaurant, farmer's market, etc.) for growth of the agricultural products and to reduce the number of participants (i.e., transitions) involved in the handling chain. Additionally, products that prosper in warm climates may be grown in cold climates within the shipping container 12, and vice versa.

The growing area 14 may be segmented into one zone or a plurality of zones 18. In the illustrated embodiment, three zones are shown, but it is to be appreciated that more or less zones may be defined within the shipping container 12. The plurality of zones 18 may be disposed in any conceivable arrangement in a manner that is dictated by the particular application. For example, one zone may be smaller or differently shaped than another zone.

Regardless of the precise number or shape of zones, the system 10 is configured to independently adjust at least one environmental condition of each zone. Independent control of each zone allows for growing of different agricultural products that benefit from distinct environmental conditions. The at least one environmental condition refers to the control and regulation of temperature, humidity, lighting, lighting quality, carbon dioxide, and ethylene levels, for example. The precise desired combination of conditions for one product may be different from another product and the independent control allows the individual needs to be met.

The system 10 includes a remote evaporator 20 that is operatively coupled to the shipping container 12. In the illustrated embodiment, the evaporator 20 is disposed on an outer surface of the shipping container 12, but it is to be appreciated that the evaporator 20 may be disposed at an interior location. The evaporator 20 controls the at least one environmental condition within each particular zone. The evaporator 20 may be part of a transport refrigeration unit (TRU) that controls temperature within the container 12. The TRU may include a compressor, condenser, expansion device and the evaporator 20, as is typical with such systems.

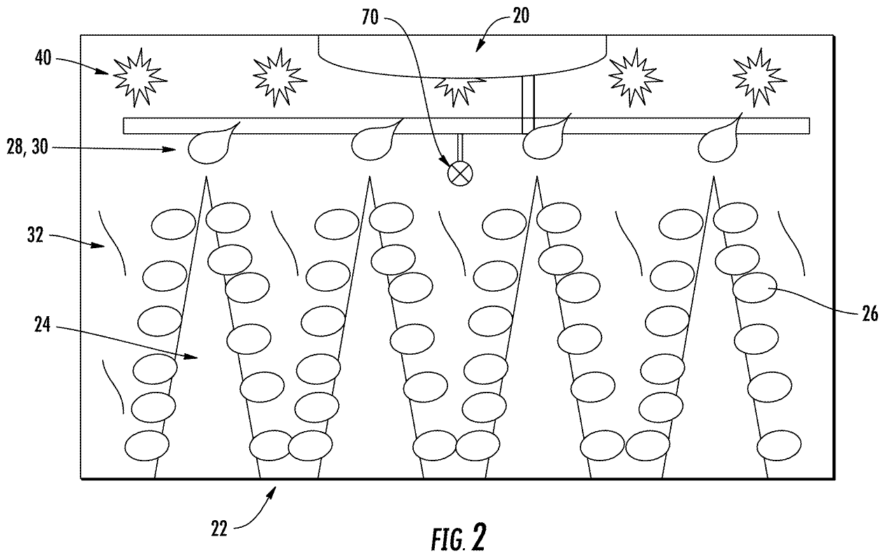

Referring to FIG. 2, with continued reference to FIG. 1, in some embodiments a hydroponics system 22 is provided to avoid the need for soil during growth of the agricultural products. In the illustrated embodiment, each zone 18 includes a hydroponics stand 24 that supports the agricultural products 26. Water 28 is provided to the hydroponics stand 24, as needed. To increase efficiency of the hydroponics system 22, the water 28 provided may be supplemented by condensate 30 formed by the evaporator 20 with the use of respiration loads 32 that are emitted from the agricultural products 26.

A lighting system 40 is disposed in the shipping container 12 to provide lighting for the agricultural products 26, as needed. As with the above-described environmental conditions, the agricultural products grown in each individual zone may benefit from different lighting levels, lighting spectrum, and the independent control is further enhanced by the ability to provide distinct lighting quality to each zone 18. The lighting system 40 may include any suitable light source, including a plurality of LEDs, for example, to achieve the optimum lighting spectrum for the particular agricultural product. Based on the self-managed electric nature of the shipping container 12, the lighting system 40 is powered by the shipping container 12 and does not require an auxiliary power source. In addition, a light spectrum analyzer 70 is manually or wirelessly connected to the TRU system (10) controller and will adjust the LED's for optimized agricultural growth.

Referring again to FIG. 1, the evaporator 20 may be interfaced with manually in some embodiments, such that controls and interfaces are located directly on the evaporator 20 and/or shipping container 12. Alternatively, or in combination with on-site control, a control device 50 that is in wireless communication with the system 10, including the evaporator 20, may be used to provide user control over the at least one environmental condition within the shipping container zone(s). In particular, a controller associated with the system 10 is in operative communication with the evaporator 20 to control the operation of the zones 18. The controller is configured to receive, process and transmit data to effect operation of the evaporator 20 in a manner that produces a desired environmental condition within the zone(s) 18. As shown, the control device 50 may be any suitable device that wirelessly communicates with the controller.

In addition to providing remote control with the control device 50, remote monitoring capabilities are enabled by the control device 50 in some embodiments. For example, the control device may be in wireless communication with at least one condition detector disposed in the shipping container to monitor the environmental condition of the zone(s) 18. The condition detector may be any instrument configured to monitor one or more environmental conditions, such as temperature, humidity, carbon dioxide, ethylene and lighting, for example. In addition, a light spectrum analyzer (70) is manually or wirelessly connected to the TRU system 10 controller and will adjust the LEDs for optimized agricultural growth

As shown in FIG. 1, an embodiment of the system 10 includes one or more data collection devices in wireless communication with a cloud data storage system 60 for tracking environmental conditions of the shipping container and/or growth progress of the agricultural products. For embodiments including the above-described control device 50, the cloud data storage system 60 may be accessible by and interactive with the control device 50.

The wireless communications described above refers to any suitable wireless communication, including cellular, Wi-Fi and/or Bluetooth communication.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. An environmental control and transport system for agricultural products comprising:
a shipping container comprising at least one zone for containing an agricultural product therein, wherein the shipping container is a self-powered electric unit; and
an evaporator operatively coupled to the shipping container, the evaporator controlling at least one environmental condition of the at least one zone.

2. The environmental control and transport system of claim 1, further comprising a hydroponics system disposed in the shipping container for growth of the agricultural product, the hydroponics system comprising at least one hydroponics support for supporting the agricultural product, wherein respiration loads produced by the agricultural product is condensed by the evaporator to form condensate that supplements the hydroponics system.

3. The environmental control and transport system of claim 1, wherein the at least one zone of the shipping container comprises a plurality of zones, wherein the at least one environmental condition of each of the zones are independently controllable with the evaporator.

4. The environmental control and transport system of claim 1, wherein the at least one environmental condition comprises at least one of temperature, lighting quality, humidity, carbon dioxide and ethylene.

5. The environmental control and transport system of claim 1, further comprising a control device in wireless communication with the evaporator, the control device providing a user control over the at least one environmental condition within the shipping container.

6. The environmental control and transport system of claim 5, wherein the control device is in wireless communication with at least one condition detector disposed in the shipping container to monitor the environmental condition of the at least one zone within the shipping container.

7. The environmental control and transport system of claim 1, wherein the shipping container includes at least one data collection device in wireless communication with a cloud data storage system for tracking environmental conditions of the shipping container and growth of the agricultural product.

8. The environmental control and transport system of claim 1, further comprising a lighting system disposed within the shipping container.

9. The environmental control and transport system of claim 8, wherein the lighting system comprises a plurality of LEDs.

10. The environmental control and transport system of claim 8, wherein the lighting system is powered by the shipping container.

11. The environmental control and transport system of claim 9, the lighting system comprising a plurality of light spectrum analyzers manually or wirelessly connected to a system controller and configured to adjust the plurality of LEDs for optimized agricultural growth.

12. The environmental control and transport system of claim 1, wherein the shipping container includes a plurality of wheels for transport of the agricultural product.

13. A method of agricultural product growth and transport comprising:
growing an agricultural product within a shipping container with a hydroponics system disposed in the shipping container;
controlling at least one environmental condition with an evaporator mounted to the shipping container; and
transporting the agricultural product to a destination within the shipping container.

14. The method of claim 13, further comprising independently controlling the at least one environmental condition of a plurality of zones of the shipping container to selectively provide distinct growing conditions for the agricultural product.

15. The method of claim 13, further comprising condensing respiration loads from the agricultural product to form a condensate that supplements the hydroponics system.

16. The method of claim 13, further comprising controlling the evaporator with a device wirelessly connected to the evaporator.

17. The method of claim 13, further comprising:
collecting data with a data collection device disposed within the shipping container; and
transporting the data collected to a cloud storage device.
